(19) United States
(12) Patent Application Publication
(10) Pub. No.: US 2017/0366062 A1
(43) Pub. Date: Dec. 21, 2017

(54) MOTOR

(71) Applicant: Nidec Corporation, Minami-ku (JP)

(72) Inventors: Shigekatsu MATSUDA, Minami-ku (JP); Keizo FURUKAWA, Minami-ku (JP)

(21) Appl. No.: 15/613,912

(22) Filed: Jun. 5, 2017

Related U.S. Application Data
(60) Provisional application No. 62/351,688, filed on Jun. 17, 2016.

(51) Int. Cl. H02K 5/167; H02K 5/18; H02K 5/08; H02K 5/128; H02K 5/06

(52) U.S. Cl. CPC H02K 5/1672; H02K 5/18; H02K 5/08; H02K 5/06; H02K 2005/1287

(57) ABSTRACT

A motor includes a motor body part and a cap member. The motor body part includes a stationary unit, a rotary unit arranged to rotate about a center axis, and a bearing fixed to the stationary unit and arranged to rotatably support the rotary unit. The cap member includes a top surface portion extending perpendicularly to the center axis, a bottom surface portion disposed below the top surface portion and having a larger outer diameter than the top surface portion, and a connecting portion which connects the top surface portion and the bottom surface portion. The connecting portion includes a first connecting portion which connects an outer edge of the top surface portion and an outer edge of the bottom surface portion, and a second connecting portion which connects the outer edge of the top surface portion and an inner edge of the bottom surface portion.

### CROSS REFERENCE TO RELATED APPLICATION

The present invention claims priority under 35 U.S.C. §119 to U.S. Application No. 62/351,688 filed Jun. 17, 2016, the entire content of which is incorporated herein by reference.

### FIELD OF THE INVENTION

The present invention relates to a motor.

### DESCRIPTION OF THE RELATED ART

Conventionally, a housing for accommodating a motor is known. For example, the housing includes a cover member for covering a stator of a motor, and a cap member for covering the upper side of a motor.

When the top surface of the cap member is a planar surface extending in a direction perpendicular to a center axis, the cap member has low rigidity. Therefore, when a motor rotates, the natural frequency of the cap member and the natural frequency of the motor may resonate, whereby a noise is generated.

By increasing the rigidity of the cap member, it is possible to shift the natural frequencies of the cap member and the motor. For example, by installing a rib in a cap member or increasing the thickness of the cap member, the rigidity of the cap member increases.

### BRIEF DESCRIPTION OF THE DRAWINGS

FIG. 1 is a vertical sectional view of a motor.

FIG. 2 is a perspective view of a cap member.

FIG. 3 is a perspective view of the cap member.

FIG. 4 is a plan view of the motor.

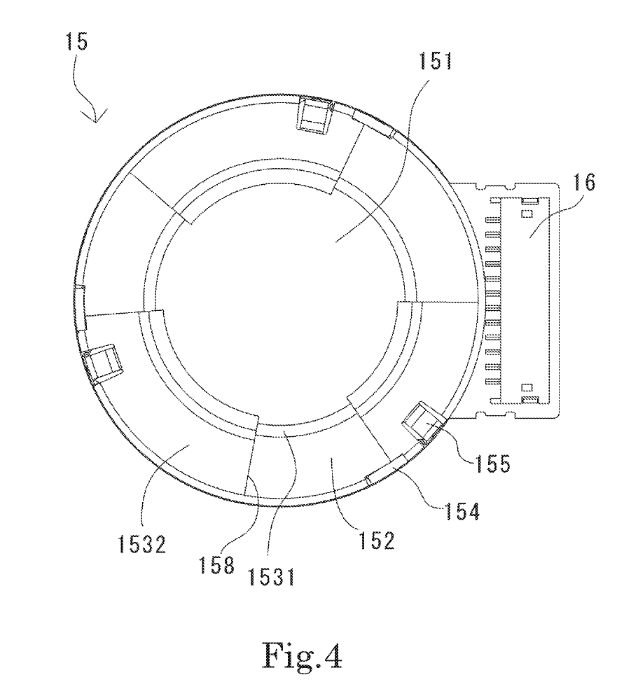

### DETAILED DESCRIPTION OF THE PREFERRED EMBODIMENTS

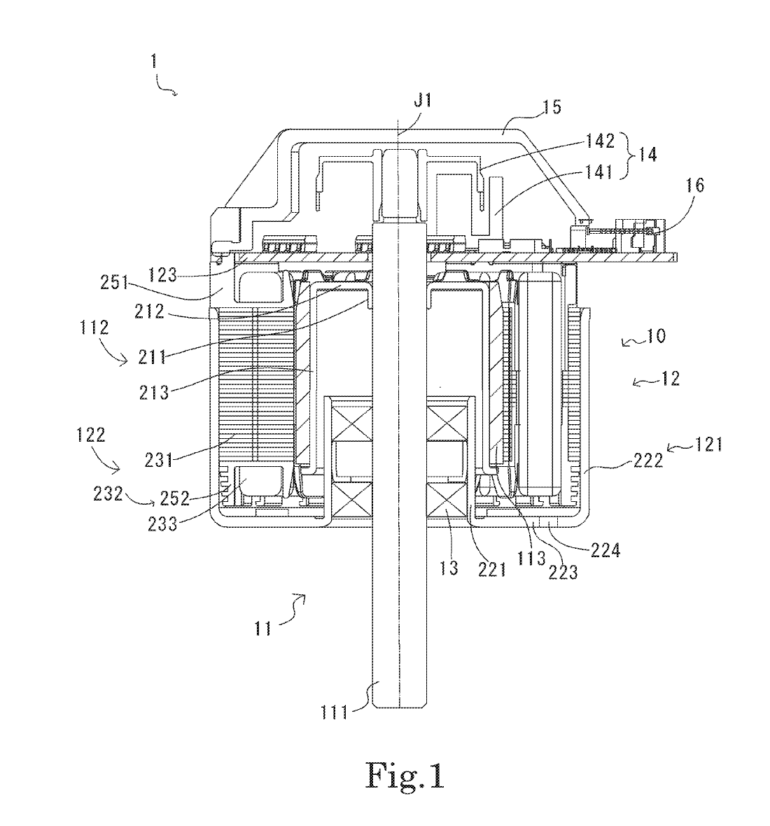

In the subject specification, in the direction parallel to the center axis, the upper side in FIG. 1 will be referred to as “upper side”, and the lower side in FIG. 1 will be simply referred to as “lower side”. The expressions “upper side” and “lower side” do not necessarily have to coincide with the direction of gravity. In addition, the radial direction about the center axis will be simply referred to as “radial direction”, the circumferential direction about the central axis will be simply referred to as “circumferential direction”, and the direction parallel to the central axis will be simply referred to as “axial direction”.

FIG. 1 is a vertical sectional view of a motor 1 according to one exemplary embodiment of the present invention. The motor 1 is, for example, an inner rotor type motor used as a driving source for office equipment such as a copying machine, a printer, a multifunction machine or the like.

As shown in FIG. 1, the motor 1 includes a rotary unit 11, a stationary unit 12, two bearings 13, an encoder 14, and a cap member 15. The rotary unit 11 rotates about a center axis J1 extending in a vertical direction. The output shaft of the rotary unit 11 faces downward. Hereinafter, the portion of the motor 1 other than the cap member 15 will be referred to as a “motor body part 10”.

The bearings 13 are fixed to the stationary unit 12 and are arranged to rotatably support the rotary unit 11. The bearings 13 include a first bearing 131 disposed on the lower side of a shaft 111 and a second bearing (not shown) disposed on the upper side of the shaft 111. The bearings 13 are, for example, ball bearings. The bearings 13 may be oil-impregnated sleeves. The cap member 15 has a lid shape and covers the upper side of a stator 122. The encoder 14 is arranged inside the cap member 15.

The rotary unit 11 includes the shaft 111, a rotor holder 112, and a rotor magnet 113. The shaft 111 is formed in a substantially circular columnar shape using the the center axis J1 as a center thereof and is rotatably supported by the bearings 13. The rotor holder 112 is connected to the side opposite to the output side of the shaft 111. The rotor holder 112 includes a shaft fixing portion 211, a connecting portion 212, and a cylindrical portion 213. The shaft fixing portion 211 is fixed to the shaft 111 on the upper side of the second bearing. The connecting portion 212 extends radially outward from the axial upper edge portion of the shaft fixing portion 211. The cylindrical portion 213 extends downward from the radial outer edge portion of the connecting portion 212. The rotor magnet 113 is attached to the outer surface of the cylindrical portion 213. The rotor magnet 113 may have a cylindrical shape. Alternatively, a plurality of magnets may be arranged in the circumferential direction. The rotor holder 112 is formed by pressing a thin plate. The thin plate is made of, for example, a magnetic material which is a metal.

As shown in FIG. 1, the stationary unit 12 includes a cover member 121, a stator 122, and a circuit board 123.

The cover member 121 includes an inner cylindrical portion 221, an outer cylindrical portion 222, and a bottom portion 223. The inner cylindrical portion 221 and the outer cylindrical portion 222 are formed in a cylindrical shape using the center axis J1 as a center thereof and are disposed coaxially. The bottom portion 223 connects the lower end of the outer cylindrical portion 222 and the lower end of the inner cylindrical portion 221. The bottom portion 223 is preferably provided with a plurality of attachment holes 224 for attaching the motor 1 to a desired position. The inner cylindrical portion 221 supports the first bearing 131 on the inner surface thereof. The outer cylindrical portion 222 covers the outer periphery of the stator 122 and supports the stator 122 on the inner surface thereof. The cover member 121 is formed by pressing a single plate member made of a metal. Preferably, the cover member 121 is an electrically conductive member. More preferably, the cover member 121 is a magnetic body.

The stator 122 preferably further includes a spacer (not shown). The spacer is formed in an axially-extending cylindrical shape around the central axis J1. The spacer is arranged coaxially with the inner cylindrical portion 221 and the outer cylindrical portion 222 of the cover member 121. The spacer includes a fixing portion fixed to the inner cylindrical portion 221 at the lower side and a bearing holding portion holding the second bearing at the upper side. The spacer is formed by pressing a single plate member made of a metal. Preferably, the spacer is an electrically conductive member. More preferably, the spacer is a magnetic body.

The stator 122 includes a stator core 231, an insulator 232, and a coil 233. The stator 122 is formed in an annular shape with the center axis J1 used as a center thereof. The stator core 231 is formed by stacking a plurality of thin magnetic steel plates in the vertical direction. Although not shown, the stator core 231 is preferably composed of an annular core back and a plurality of teeth. The core back is press-fitted into the outer cylindrical portion 222. The teeth extend radially inward from the core back. The rotor magnet 113 is arranged inside the stator 122. The tips of the teeth face the rotor magnet 113 in the radial direction.

The insulator 232 is made of a resin. The insulator 232 covers the stator core 231. The insulator 232 is preferably composed of nine upper insulators 251 and nine lower insulators 252. Each of the upper insulators 251 covers the upper surface and the upper half of the side surface of one tooth 242. Each of the lower insulators 252 covers the lower surface and the lower half of the side surface of one tooth 242.

Although not shown, each of the upper insulators 251 includes an outer protruding portion and an inner protruding portion. The outer protruding portion protrudes upward from the upper end of the outer cylindrical portion 222 on the radial outer side of the coil 233. The outer protruding portion is also an upper portion of the outer cylindrical portion 222 of the insulator 232. The inner protruding portion protrudes upward on the upper side of the tip of the tooth 242. The outer protruding portion includes a projection protruding upward. That is, at least one of the upper insulators includes a projection protruding radially outward and upward. The projection protrudes relatively radially outward because the surrounding thereof is a recess.

Each of the lower insulators 252 includes an outer protruding portion protruding downward on the radial outer side of the coil 233 and an inner protruding portion protruding downward on the lower side of the tip of the tooth 242. The stator core 231 is covered by the upper insulators 251 and the lower insulators 252, except for the outer surface of the core back and the tip surfaces of the teeth.

The circuit board 123 is positioned above the stator 122 and extends in a direction perpendicular to the center axis J1. The circuit board 123 is held above the insulator 232.

The coil 233 is formed by winding a conductive wire in multiple layers from the top of the insulator 232 to the respective teeth. When a current flows from the circuit board 123 to the coil 233, a torque is generated between the coil 233 and the rotor magnet 113. As a result, the rotary unit 11 rotates about the center axis J1.

While not shown, the encoder 14 includes a sensor portion and a plate portion. The sensor portion is attached to the upper surface of the circuit board 123. The plate portion is perpendicular to the center axis J1 and is attached to the shaft 111. The rotation speed of the shaft 111 is detected as the sensor portion optically detects the passage of a slit formed in the plate portion. Instead of the encoder 14, an FG (Frequency Generator) pattern may be formed on the circuit board 123, and an FG magnet may be arranged on the connecting surface 212 of the rotor holder 112.

A magnetic sensor (not shown) is attached to the lower surface of the circuit board 123. The magnetic sensor is supported by the circuit board 123 above the rotor magnet 113. The rotational position of the rotor magnet 113, namely the rotation of the rotary unit 11, is detected by the magnetic sensor. In the motor 1, a Hall element is used as the magnetic sensor. As the magnetic sensor, an FG pattern formed on the circuit board 123 and supported by the circuit board 123 above the rotor magnet 113 may be used.

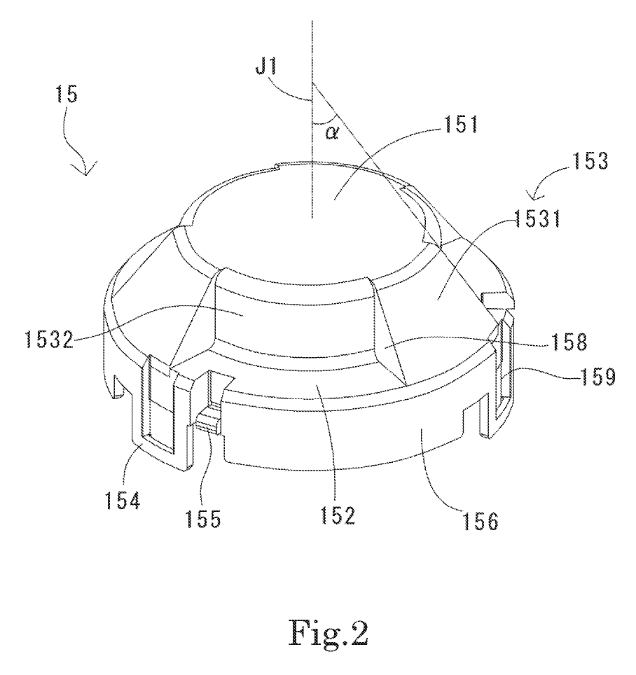

FIG. 2 is a perspective view of the cap member 15 as viewed obliquely from above. In the present embodiment, the cap member 15 is formed by injection molding of a resin. By the injection molding, the cap member 15 can be obtained with ease. Alternatively, the cap member may be formed by pressing a single metal plate member. The cap member 15 has a lid shape opened downward, and the encoder 14 is disposed inside the cap member 15. The cap member 15 includes a top surface portion 151, a bottom surface portion 152, a connecting portion 153, a snap fit portion 154, an elastic portion 155, and a cylindrical portion 156.

The top surface portion 151 is the upper surface of the cap member 15 and extends perpendicularly to the center axis J1. The top surface portion 151 covers the upper side of the encoder 14. The connecting portion 153 connects the top surface portion 151 and the bottom surface portion 152.

The expression that the outer diameter of the bottom surface portion 152 is larger than the outer diameter of the top surface portion 151 includes a case where the maximum outer diameter of the bottom surface portion 152 is larger than the maximum outer diameter of the top surface portion 151. That is, the expression that the outer diameter of the bottom surface portion 152 is larger than the outer diameter of the top surface portion 151 also includes a case where the outer diameter of a part of the bottom surface portion 152 is smaller than the maximum outer diameter of the top surface portion 151 as long as the maximum outer diameter of the bottom surface portion 152 is larger than the maximum outer diameter of the top surface portion 151.

The connecting portion 153 includes a first connecting portion 1531 and a second connecting portion 1532. The first connecting portion 1531 is a surface that connects the outer edge of the top surface portion 151 and the outer edge of the bottom surface portion 152. That is, the first connecting portion 1531 is an inclined surface whose outer diameter increases from the axial upper side toward the axial lower side. The second connecting portion 1532 is a surface that connects the outer edge of the top surface portion 151 and an imaginary circle 157. The imaginary circle 157 is smaller in diameter than the outer edge of the bottom portion 152 and larger in diameter than the outer edge of the top surface portion 151. In the present embodiment, the second connecting portion 1532 is a surface perpendicular to the top surface portion 151. That is, the second connecting portion 1532 is a surface parallel to the center axis J1. The second connecting portion 1532 may be an inclined surface whose outer diameter increases from the axial upper side toward the axial lower side. In this case, the angle between the line passing through the outer edge of the top surface portion 151 and parallel to the center axis and the second connecting portion 1532 is smaller than the angle between the line passing through the outer edge of the top surface portion 151 and parallel to the center axis and the first connecting portion 1531.

The first connecting portion 1531 and the second connecting portion 1532 are adjacent to each other in the circumferential direction. That is, the first connecting portion 1531 has an axially-extending wall surface 158 disposed on the side to which the second connecting portion 1532 is adjacent. Accordingly, the first connecting portion 1531 serves as a beam for supporting the top surface portion 151 and the bottom surface portion 152. This makes it possible to increase the rigidity of the cap member 15. Therefore, a frequency difference occurs between the natural frequency of the cap member 15 and the natural frequency of the motor body part 10. This makes it possible to suppress a noise due to resonance.

In the present embodiment, the cap member 15 includes a plurality of connecting portions 153. More preferably, there are disposed three first connecting portions 1531. The three first connecting portions 1531 are arranged at equal intervals in the circumferential direction, and the second connecting portions 1532 are disposed between the first connecting portions 1531. The number of the connecting portions 153 is not limited to three and may be two or four or more. The number of the connecting portions 153 may be appropriately selected for the purpose of changing the rigidity of the cap member 15 to obtain a natural frequency different from the natural frequency of the motor body part 10.

In the present embodiment, the first connecting portion 1531 is a single surface that connects the outer edge of the top surface portion 151 and the outer edge of the bottom surface portion 152. The single surface may be divided into a plurality of surfaces. For example, when connecting the outer edge of the top surface portion 151 and the outer edge of the bottom surface portion 152, a bent portion may be provided so that the outer edge of the top surface portion 151 and the outer edge of the bottom surface portion 152 can be connected by two surfaces. In this case, more preferably, the diameter of the imaginary circle 157 is different from the diameter of the bent portion. By virtue of these different diameters, it is possible to obtain a truss structure and to make the cap member 15 become a component with higher rigidity.

The cylindrical portion 156 extends downward from the outer edge portion of the bottom surface portion 152 toward the motor body part 10.

The snap fit portion 154 protrudes downward from the cylindrical portion 156. The snap fit portion 154 is annular when viewed from the radial outer side. The elastic portion 155 is circumferentially adjacent to the snap fit portion 154. The cylindrical portion 156 includes a recess 159 extending downward from the upper end thereof, namely from the bottom surface portion, and recessed radially inward. The recess 159 is defined by a plurality of side surfaces parallel to the center axis J1. A plurality of snap-fit portions 154 having the same shape are arranged in the circumferential direction. A plurality of elastic portions 155 having the same shape are also arranged in the circumferential direction. In the present embodiment, the snap fit portions 154 are arranged at equal intervals in the circumferential direction. The elastic portions 155 are arranged at equal intervals in the circumferential direction.

At the lower end of the recess 159, the elastic portion 155 extends radially outward from the surface defining the recess 159. By providing the elastic portion 155 in this way, it is possible to easily manufacture a mold for injection molding. The elastic portion 155 is located inside the recess 159. By providing the recess 159, it is possible to secure a large space inside the cap member 15. In addition, by providing the recess 159 so as to extend in the vertical direction, it is possible to easily perform the molding of the cap member 15, especially the injection molding of the cap member 15 with a resin.

The snap fit portion 154 engages with a protrusion. Thus, the cap member 15 is fixed to the insulator 232. The cap member 15 is attached to the outer surface of the outer protruding portion above the outer cylindrical portion 222.

The first connecting portion 1531 is disposed at a position overlapping with the snap fit portion in the circumferential direction. That is, the first connecting portion 1531 is disposed at a fixed position. As a result, it is possible to further increase the rigidity of the cap member 15.

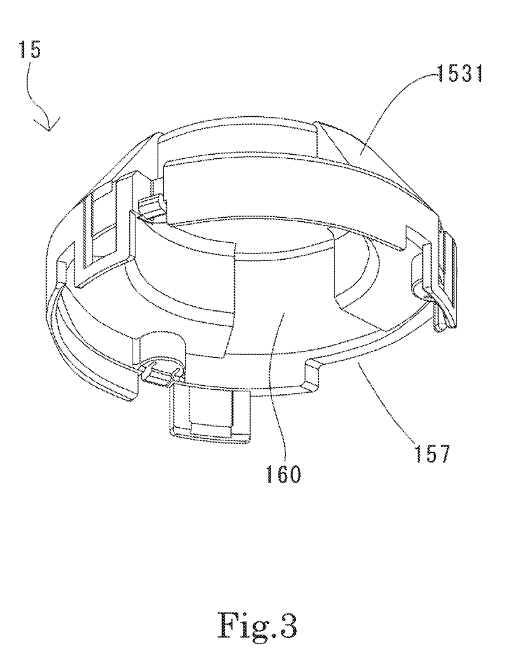

FIG. 3 is a perspective view of the cap member 15 as viewed obliquely from below. A space 160 is provided inside the first connecting portion 1531. The encoder 14 is disposed inside the space 160. The space 160 may not be provided in the first connecting portion 1531. That is, the thickness of the first connecting portion 1531 may be larger than the thickness of the top surface portion 151.

In the present embodiment, the first connecting portion 1531, the second connecting portion 1532 and the bottom surface portion 152 are planar surfaces such as inclined surfaces or the like. However, the present invention is not limited thereto. At least one of the first connecting portion 1531, the second connecting portion 1532 and the bottom surface portion 152 may be a curved surface. In other words, the outer edge of the top surface portion 151 and the outer edge of the bottom surface portion 152 may be connected by the curved surface in which the first connecting portion 1531 and the bottom surface portion 152 are continuous. Similarly, in the first connecting portion 1531, the outer edge of the top surface portion 151 and the outer edge of the bottom surface portion 152 may be connected by a curved surface.

While preferred embodiments of the present invention have been described above, it is to be understood that variations and modifications will be apparent to those skilled in the art without departing from the scope and spirit of the present invention.

What is claimed is:

1. A motor, comprising:
a motor body part; and
a cap member attached to the motor body part,
wherein the motor body part includes a stationary unit, a rotary unit arranged to rotate about a center axis extending in a vertical direction, and a bearing fixed to the stationary unit and arranged to rotatably support the rotary unit,
the cap member includes a top surface portion extending substantially perpendicularly to the center axis, a bottom surface portion disposed below the top surface portion and having a larger outer diameter than the top surface portion, and a connecting portion which connects the top surface portion and the bottom surface portion, and
the connecting portion includes a first connecting portion which connects an outer edge of the top surface portion and an outer edge of the bottom surface portion, and a second connecting portion which connects the outer edge of the top surface portion and an inner edge of the bottom surface portion.

2. The motor of claim 1, wherein an angle between the center axis and an outer surface of the second connecting portion is smaller than an angle between the center axis and an outer surface of the first connecting portion.

3. The motor of claim 1, wherein an outer surface of the first connecting portion is an inclined surface whose outer diameter increases from an axial upper side toward an axial lower side.

4. The motor of claim 1, wherein an outer surface of the second connecting portion is a surface parallel to the center axis.

5. The motor of claim 1, wherein the first connecting portion and the second connecting portion are adjacent to each other in a circumferential direction, and
the first connecting portion includes an axially-extending wall surface on a circumferentially-facing surface side to which the second connecting portion is adjacent.

6. The motor of claim 1, wherein the motor body part further includes an encoder on an axial upper side thereof, and
the encoder is covered with the cap member.

7. The motor of claim 6, wherein the encoder radially faces the second connecting portion.

8. The motor of claim 8, wherein the first connecting portion and the second connecting portion are adjacent to each other in a circumferential direction, and
the first connecting portion includes an axially-extending wall surface on a circumferentially-facing surface side to which the second connecting portion is adjacent.

9. The motor of claim 1, wherein the motor body part further includes a circuit board on an axial upper side thereof, and
the circuit board is covered with the cap member.

10. The motor of claim 8, wherein the cap member further includes an axially-movable elastic portion disposed in the bottom surface portion, and
the elastic portion is arranged to hold the circuit board in an axial direction.

11. The motor of claim 1, wherein the cap member further includes a snap fit portion protruding downward from an outer edge of the bottom surface portion,
the motor body part is attached to the cap member by being fixed to the snap fit portion, and
at least a part of the first connecting portion is arranged at a position overlapping with the snap fit portion in a circumferential direction.

12. The motor of claim 1, wherein the motor body part further includes an external connecting portion protruding radially outward beyond an outer diameter of the motor body part on an axial upper side thereof,
the cap member further includes a cylindrical portion extending downward from an outer edge of the bottom surface portion, and a cutout portion recessed upward from a lower end portion of the cylindrical portion, and
at least a part of the external connecting portion is accommodated in the cutout portion.
